(19) United States
(12) Patent Application Publication
(10) Pub. No.: US 2026/0094911 A1
(43) Pub. Date: Apr. 2, 2026

(54) BATTERY MODULE, BATTERY PACK, AND ELECTRICAL DEVICE

(71) Applicant: EVE ENERGY CO., LTD., Huizhou (CN)

(72) Inventors: Hao WEN, Huizhou (CN); Xiaobo DENG, Huizhou (CN); Yapeng DONG, Huizhou (CN); Dehong XU, Huizhou (CN); Chaohai CHEN, Huizhou (CN)

(73) Assignee: EVE ENERGY CO., LTD., Huizhou (CN)

(21) Appl. No.: 19/402,866

(22) Filed: Nov. 26, 2025

Related U.S. Application Data
(63) Continuation of application No. PCT/CN2025/078447, filed on Feb. 21, 2025.

(30) Foreign Application Priority Data
Sep. 30, 2024 (CN) 202422418080.4

(51) Int. Cl. H01M 50/242; H01M 50/204; H01M 50/291; H01M 50/293

(52) U.S. Cl. CPC H01M 50/242; H01M 50/291; H01M 50/293; H01M 50/204

(57) ABSTRACT

This application provides a battery module, a battery pack, and an electrical device. The battery module includes at least one battery group and multiple buffer members. The battery group includes multiple batteries arranged along a first direction. Each battery includes multiple positive electrode plates and multiple negative electrode plates alternately stacked along the first direction. In each battery, the positive electrode plate and the negative electrode plate respectively include portions that overlap with each other in the first direction to form an overlapping region, while the positive electrode plate and a remaining portion of the negative electrode plate do not overlap in the first direction, forming a non-overlapping region.

This application is a Bypass Continuation Application of PCT/CN2025/078447, filed on Feb. 21, 2025, which claims priority to Chinese Patent Application No. 202422418080.4, filed with the China National Intellectual Property Administration on Sep. 30, 2024, the entire contents of which are incorporated herein by reference.

### FIELD OF DISCLOSURE

The present application relates to a field of battery technology, and more particularly, to a battery module, a battery pack, and an electrical device.

### DESCRIPTION OF RELATED ART

In related technologies, during cycling, batteries may experience varying degrees of expansion due to factors such as lithium-ion migration and electrolyte decomposition.

### SUMMARY OF INVENTION

However, in conventional applications, batteries are connected using structural adhesives, which do not provide sufficient buffer space for battery expansion. This leads to accelerated capacity degradation during cycling, thereby affecting the cycle life of the battery.

In a first aspect, the present application provides a battery module, including:
at least one battery group, including a plurality of batteries arranged along a first direction, each battery including a plurality of positive electrode plates and a plurality of negative electrode plates alternately stacked along the first direction, wherein the positive electrode plate and the negative electrode plate respectively comprise portions that overlap with each other in the first direction in an overlapping region, while a remaining portion of the negative electrode plate is in a non-overlapping region;
a plurality of buffer members, at least one of the buffer members being disposed between two adjacent ones of the batteries;
wherein an orthographic projection of the buffer member in the first direction is located within the overlapping region and outside the non-overlapping region.

In a second aspect, the present application provides a battery pack, including the battery module.

In a third aspect, the present application provides an electrical device, comprising the battery pack.

### Advantageous Effects

The battery module provided by embodiments of the present application includes at least one battery group and a plurality of buffer members. The battery group includes a plurality of batteries arranged along a first direction, each battery including a plurality of positive electrode plates and a plurality of negative electrode plates alternately stacked along the first direction. A portion of the positive electrode plates and the negative electrode plates overlap in the first direction to form an overlapping region, while another portion is staggered to form a non-overlapping region. At least one buffer member is disposed between two adjacent batteries, with the orthographic projection of the buffer member in the first direction located within the overlapping region and outside the non-overlapping region. In the embodiments of this application, by providing a buffer member between adjacent batteries, a spacing is created to accommodate battery expansion during cycling. Additionally, the buffer member does not contact the non-overlapping region of the positive and negative electrode plates in the first direction, preventing uneven distribution of expansion forces. This slows down battery capacity degradation, thereby improving the cycle life of the battery.

### BRIEF DESCRIPTION OF DRAWINGS

FIG. 1 is an exploded schematic diagram of a battery module according to an embodiment of the present application.

FIG. 2 is a schematic diagram comparing a dimensional relationship in the first direction between a buffer member, a positive electrode plate, and a negative electrode plate within a battery, according to an embodiment of the present application.

FIG. 3 is a schematic structural diagram of the negative electrode plate according to an embodiment of the present application.

FIG. 4 is a schematic diagram comparing the dimensional relationship between the positive electrode plate and the negative electrode plate according to an embodiment of the present application.

FIG. 5 is a schematic diagram of the partial structure of the battery module according to the present application.

FIG. 6 is a schematic diagram of a fixture clamping a battery according to the present application.

FIG. 7 is a data chart showing the effects of different reserved expansion spaces on battery cycle life and expansion force according to the present application.

### DESCRIPTION OF REFERENCE NUMERALS

100: battery module; 1: battery group; 11: battery; 110: positive electrode plate; 111: negative electrode plate; 112: separator; 2: buffer member; 3: overlapping region; 4: non-overlapping region; 5: thinned portion; 6: end plate; 7: fixture; 71: clamping portion.

### DETAILED DESCRIPTION OF EMBODIMENTS

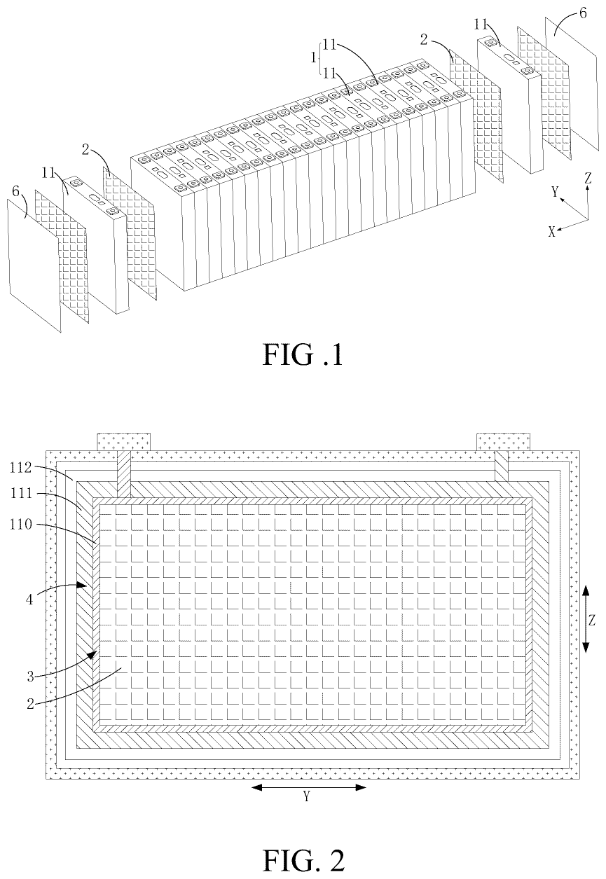

The present application provides a battery module, as illustrated in FIGS. 1 to 7, which depict some embodiments of this application. As shown in the drawings, the X direction is a first direction X, the Y direction is a second direction Y, and the Z direction is a third direction Z. The following description refers to the first direction X, the second direction Y, and the third direction Z, wherein the first direction X intersects the second direction Y, and both the first direction X and the second direction Y are perpendicular to the third direction Z.

Referring to FIGS. 1 to 3, in some embodiments of the present application, the battery module 100 includes a battery group 1. The battery group 1 includes a plurality of batteries 11 arranged along the first direction X. Each battery 11 includes a plurality of positive electrode plates 110 and a plurality of negative electrode plates 111 alternately stacked along the first direction X. The positive electrode plates 110 and the negative electrode plates 111 in each battery 11 enable electrochemical reactions to store and output electrical energy.

The positive electrode plates 110 and the negative electrode plates 111 within the battery 11 do not completely overlap in the first direction X. That is, a portion of the positive electrode plate 110 and a portion of the negative electrode plate 111 overlap in the first direction to form an overlapping region 3, while a remaining portion of the negative electrode plate 111 does not overlap with the positive electrode plate 110 in the first direction to form a non-overlapping region 4.

The manner in which the overlapping region 3 and the non-overlapping region 4 are formed between the positive electrode plates 110 and the negative electrode plates 111 is not limited. In one embodiment, the positive electrode plates 110 and the negative electrode plates 111 may have different dimensions in the plane defined by the second direction Y and the third direction Z, such that the overlapping region 3 and the non-overlapping region 4 are formed between the positive electrode plates 110 and the negative electrode plates 111.

In another embodiment, the positive electrode plate 110 and the negative electrode plate 111 do not completely overlap in the second direction Y, forming the overlapping region 3 and the non-overlapping region 4.

In yet another embodiment, the positive electrode plate 110 and the negative electrode plate 111 do not completely overlap in the third direction Z, forming the overlapping region 3 and the non-overlapping region 4.

In a further embodiment, the positive electrode plates 110 and the negative electrode plates 111 do not completely overlap in both the second direction Y and the third direction Z, forming the overlapping region 3 and the non-overlapping region 4.

In another embodiment, the positive electrode plates 110 and negative electrode plates 111 may have different dimensions in the plane defined by the second direction Y and the third direction Z, and do not completely overlap in at least one of the second direction Y and the third direction Z, thereby forming the overlapping region 3 and the non-overlapping region 4.

The type of battery 11 is not limited and may be a laminated battery or a wound battery.

In some embodiments of the present application, the battery module 100 further includes a plurality of buffer members 2, with at least one buffer member 2 disposed between two adjacent batteries 11. By providing the buffer member 2, a spacing is created between adjacent batteries 11, thereby providing a buffer space for expansion of the batteries 11 during use.

The number of buffer members 2 disposed between adjacent batteries 11 may be one or more, and is not particularly limited.

In some embodiments, the orthographic projection of the buffer member 2 in the first direction X falls within the overlapping region 3 and outside the non-overlapping region 4. With this arrangement, the buffer member 2 does not press against the non-overlapping region 4 of the positive electrode plates 110 and the negative electrode plates 111 in the battery 11, thereby avoiding uneven distribution of expansion forces.

It should be noted that the battery 11 includes an electrode assembly. The electrode assembly includes a plurality of positive electrode plates 110 and a plurality of negative electrode plates 111 alternately stacked along the first direction X. In the first direction X, the stacked thickness of the positive electrode plates 110 and the negative electrode plates 111 in the overlapping region 3 is greater than the stacked thickness of the positive electrode plates 110 and the negative electrode plates 111 in the non-overlapping region 4, and the area of the overlapping region 3 is greater than the area of the non-overlapping region 4 between the positive electrode plates 110 and the negative electrode plates 111. By ensuring that the orthographic projection of the buffer member 2 in the first direction X does not fall within the non-overlapping region 4, uneven distribution of expansion forces due to pressure on the non-overlapping region 4 is prevented. Additionally, since the buffer member 2 is positioned, in the first direction X, opposite to the overlapping region 3, which has a relatively larger area, the buffer member 2 can more effectively absorb the expansion stress of the battery 11, thereby improving the cycle life of the battery 11.

In the technical solution of the present application, the buffer members 2 are disposed between adjacent batteries 11 to provide spacing for accommodating expansion of the batteries 11 during cycling. The buffer members 2 do not contact the non-overlapping region 4 of the positive electrode plates 110 and the negative electrode plates 111 in the first direction X, thereby preventing uneven distribution of expansion forces. As a result, capacity degradation of the batteries 11 is slowed, and their cycle life is improved.

In some embodiments, the battery 11 is a lithium-ion battery. Specifically, the positive electrode plate 110 undergoes a reduction reaction or acts as a cathode during operation, while the negative electrode plate 111 undergoes an oxidation reaction or acts as an anode. During charging, lithium ions are deintercalated from the positive electrode plate 110 and intercalated into the negative electrode plate 111 through the electrolyte, rendering the negative electrode plate 111 lithium-rich. During discharging, lithium ions are released from the negative electrode plate 111 and return to the positive electrode plate 110, restoring its lithium-rich state.

To ensure the safety and stability of the battery, a separator 112 is disposed between the positive electrode plate 110 and the negative electrode plate 111 to prevent direct contact, which could lead to internal short circuits. The separator 112 allows lithium ions to migrate through it within the battery 11.

In some embodiments, in the plane defined by the second direction Y and the third direction Z, the size of the negative electrode plate 111 is larger than that of the positive electrode plate 110. This configuration helps prevent lithium plating during charging, thereby avoiding performance degradation and significant shortening of the cycle life of the lithium-ion battery.

It should be noted that lithium plating refers to a phenomenon that may occur during the charging process of the battery 11, in which lithium ions deintercalate from the positive electrode plate 110 and intercalate into the negative electrode plate 111. If there is insufficient space in the negative electrode plate 111 to accommodate the lithium ions, the increased resistance to intercalation may cause some lithium ions to remain on the surface of the negative electrode plate 111, where they gain electrons and form silvery-white metallic lithium.

In some embodiments, the orthographic projection of the positive electrode plate 110 in the first direction X lies entirely within the negative electrode plate 111, thereby forming the overlapping region 3. In other words, the peripheral portion of the positive electrode plate 110 does not extend beyond the peripheral portion of the negative electrode plate 111. This configuration facilitates the complete separation of the positive and negative electrode plates 110, 111 by the separator 112, thereby preventing direct contact and avoiding the risk of internal short circuits within the battery 11.

In addition, configuring the orthographic projection of the positive electrode plate 110 in the first direction X to lie entirely within the negative electrode plate 111 can further improve space utilization within the battery 11, thereby enhancing the energy density of the battery 11.

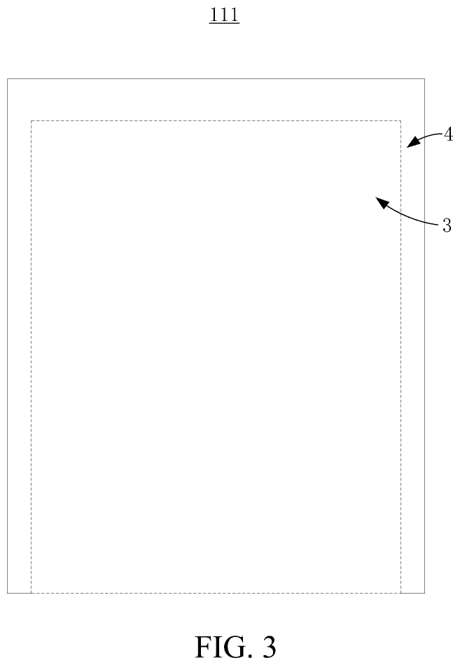

Referring to FIG. 3, since the orthographic projection of the positive electrode plate 110 in the first direction X lies entirely within the negative electrode plate 111, both the overlapping region 3 and the non-overlapping region 4 are located on the negative electrode plate 111. In FIG. 3, the dashed-line framed area on the negative electrode plate 111 represents the overlapping region 3, and the area outside the dashed-line frame represents the non-overlapping region 4.

In some embodiments, since the orthographic projection of the positive electrode plate 110 in the first direction X lies entirely within the negative electrode plate 111, the area of the overlapping region 3 between the positive electrode plate 110 and the negative electrode plate 111 in the plane defined by the second direction Y and the third direction Z is equal to the area of the positive electrode plate 110. The orthographic projection of the buffer member 2 in the first direction X lies entirely within the positive electrode plate 110, thereby reducing uneven distribution of expansion forces in the battery 11, slowing down capacity degradation, and improving the cycle life of the battery 11.

The dimensional relationship between the buffer member 2 and the positive electrode plate 110 in the plane defined by the second direction Y and the third direction Z is not limited.

In one embodiment, the size of the buffer member 2 is smaller than the size of the positive electrode plate 110 in the plane defined by the second direction Y and the third direction Z.

In another embodiment, the size of the buffer member 2 is equal to the size of the positive electrode plate 110 in the plane defined by the second direction Y and the third direction Z.

In some embodiments, the size of the buffer member 2 in the plane defined by the second direction Y and the third direction Z is the same as the size of the positive electrode plate 110. This design ensures that the entire portion of the buffer member 2 has an orthographic projection in the first direction X that coincides with the overlapping region 3 between the positive electrode plates 110 and the negative electrode plates 111. As a result, uneven distribution of expansion forces in the battery 11 is reduced, thereby slowing capacity degradation and improving the cycle life of the battery 11.

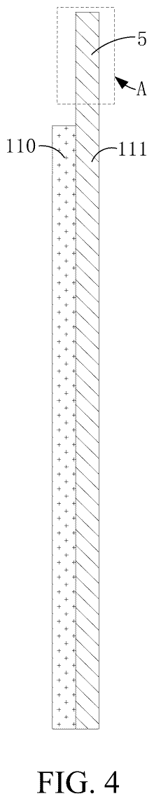

Referring to FIG. 4, in some embodiments, the negative electrode plate 111 includes a thinned portion 5 located in the non-overlapping region 4. That is, the thinned portion 5 of the negative electrode plate 111 does not oppose the positive electrode plate 110 in the first direction X, thereby preventing accelerated lithium deposition in the thinned portion 5.

It should be noted that, due to the insufficient capacity of the thinned portion 5 of the negative electrode plate 111 relative to the positive electrode plate 110, lithium ions deintercalating from the positive electrode plate 110 during charging cannot fully intercalate into the thinned portion 5, thereby otherwise causing accelerated lithium deposition in this region.

Referring to FIG. 4, the dashed area illustrates the thinned portion 5 of the negative electrode plate 111. The size and position of the thinned portion 5 are not limited to the dashed area shown in FIG. 4 and may be designed based on actual production needs.

In some embodiments, the positive electrode plate 110 also includes a thinned portion 5. Due to the different sizes of the positive electrode plate 110 and the negative electrode plate 111, the size and position of the thinned portion 5 on the positive electrode plate 110 may be the same as or different from those on the negative electrode plate 111.

It should be noted that the formation of the thinned portion 5 on at least one of the positive electrode plate 110 and the negative electrode plate 111 is due to the uneven slurry coverage caused by the fluid nature of the coating slurry during the coating process. By thinning designated areas, the uniformity of the coating layer can be ensured, thereby increasing battery capacity, reducing internal resistance, extending cycle life, and enhancing safety.

The portion of the positive electrode plate 110 with the thinned portion 5 has a smaller thickness in the first direction X than the portion without the thinned portion 5. Similarly, the portion of the negative electrode plate 111 with the thinned portion 5 has a smaller thickness in the first direction X than the portion without the thinned portion 5.

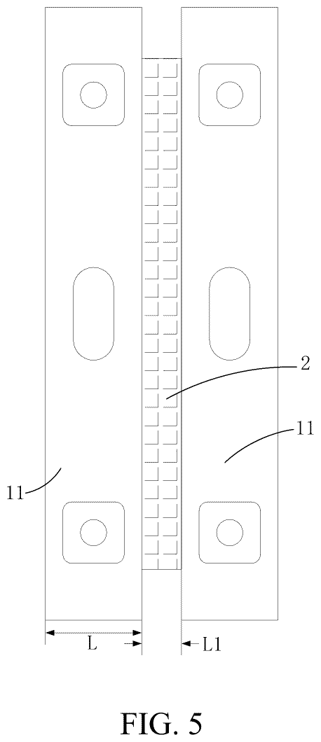

Referring to FIG. 5, in some embodiments, the battery 11 has a length L in the first direction X, and the spacing between two adjacent batteries 11 in the first direction X is L1. The values of L and L1 satisfy the relationship: 0.02L≤L1≤0.05L. Configuring L1 within this range improves the capacity retention of the battery 11 during cycling, thereby enhancing its cycle life.

The ratio of L1 to L may include, but is not limited to, L1=0.02L, 0.021L, 0.022L, 0.023L, 0.024L, 0.025L, 0.026L, 0.027L, 0.028L, 0.029L, 0.03L, 0.031L, 0.032L, 0.033L, 0.034L, 0.035L, 0.036L, 0.037L, 0.038L, 0.039L, 0.04L, 0.041L, 0.042L, 0.043L, 0.044L, 0.045L, 0.046L, 0.047L, 0.048L, 0.049L, or 0.05L. These values are illustrative rather than limiting, and other unlisted ratios within this range are equally applicable.

In some embodiments, L and L1 satisfy: L:L1=1:0.03. This ratio optimizes the capacity retention rate, enhancing the cycle life of the battery 11. In some embodiments, L and L1 satisfy the ratio L:L1=1:0.03. Configuring L and L1 according to this ratio can improve the capacity retention rate during cycling, thereby enhancing the cycle life of the battery 11.

In some embodiments, the buffer member 2 is elastic and has a compressed state and an uncompressed state. In the first direction X, the size of the buffer member 2 in the compressed state is smaller than in the uncompressed state. That is, the buffer member 2 is capable of elastic deformation in the first direction X.

In some embodiments, the buffer member 2 between two adjacent batteries 11 is in the compressed state, enabling the buffer member 2 to apply a preload force to the batteries 11, reducing capacity degradation and improving cycle life.

It should be understood that during assembly, a preload force is applied to the batteries 11, and the buffer member 2 reserves expansion space, slowing capacity degradation and reducing expansion during the lifespan of the battery 11.

Additionally, since the battery 11 tends to contract during the initial cycles, the buffer member 2, capable of undergoing elastic deformation in the first direction X, can continue to apply a certain preload force to the battery 11 even after its contraction. This helps prevent the battery 11 from shifting within the battery module 100 due to shrinkage of the battery 11.

In some embodiments, the dimension of the buffer member 2 in the first direction X is D1 in the uncompressed state and D2 in the compressed state, where D1 and D2 satisfy: 0.41D1≤D2≤0.45D1. The ratio of D2 to D1 represents the compression ratio of the buffer member 2 in the first direction X. The buffer member 2 with a compression ratio in this range can apply an appropriate preload force to the battery 11, thereby reducing capacity degradation during cycling and improving the cycle life of the battery 11.

In some embodiments of the present application, the buffer member 2 is made of irradiated cross-linked polypropylene foam.

In some embodiments, buffer members 2 are disposed on opposite sides of the battery 11 in the first direction X. The two buffer members 2 are symmetrical and have the same dimension in the first direction X.

In some embodiments, the battery module 100 further includes two end plates 6, and the two end plates 6 are respectively located on opposite sides of the battery group 1 in the first direction X. These end plates 6 serve to secure the plurality of batteries 11 in place and apply a preload force to them.

In some embodiments, a buffer member 2 is disposed between the end plate 6 and an adjacent battery 11. This configuration provides an expansion space and allows the buffer member 2 to absorb the expansion stress of the battery 11, thereby improving the cycle life of the battery 11 adjacent to the end plate 6.

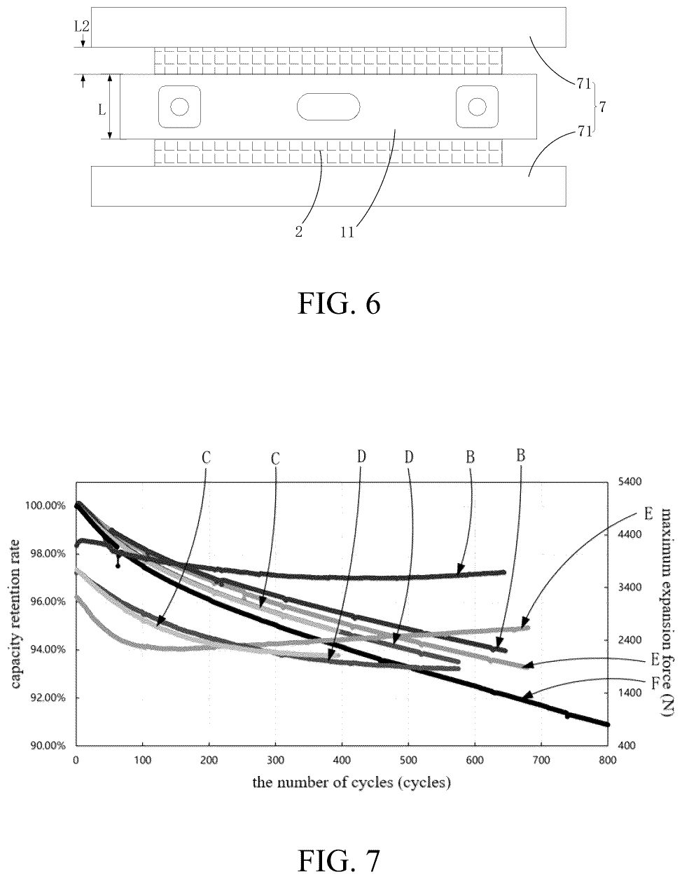

Referring to FIG. 6, buffer members 2 are disposed on opposite sides of the battery 11 in the first direction X, and a fixture 7 applies a preload force to the battery 11 and the buffer members 2. The fixture 7 includes two clamping portions 71 which are arranged opposite to each other in the first direction X to clamp the battery 11. In the first direction X, the spacing between each clamping portion 71 and the battery 11 is the same and denoted as L2.

Additionally, the orthographic projection of the positive electrode plate 110 in the first direction X lies entirely within the negative electrode plate 111. The orthographic projection of the buffer member 2 in the first direction X lies entirely within the positive electrode plate 110, and the size of the buffer member 2 in the plane defined by the second direction Y and the third direction Z is equal to the size of the positive electrode plate 110 in the same plane.

In Examples 1 to 5 and Comparative Example 1 described below, the battery 11 is subjected to a preload force in the range of 2800 N to 3200 N and is discharged at the maximum depth of discharge at a temperature of 35° C.

Example 1: The spacing L2 between the clamping portion 71 of the fixture 7 and the battery 11 in the first direction X is 0.02L. The experimental data result in Example 1 is indicated by arrow C in FIG. 7.

Example 2: The spacing L2 between the clamping portion 71 of the fixture 7 and the battery 11 in the first direction X is 0.03L. The experimental data result in Example 2 is indicated by arrow B in FIG. 7.

Example 3: The spacing L2 between the clamping portion 71 of the fixture 7 and the battery 11 in the first direction X is 0.04L. The experimental data result in Example 3 is indicated by arrow E in FIG. 7.

Example 4: The spacing L2 between the clamping portion 71 of the fixture 7 and the battery 11 in the first direction X is 0.05L. The experimental data result in Example 4 is indicated by arrow D in FIG. 7.

Comparative Example 1: The spacing L2 between the clamping portion 71 of the fixture 7 and the battery 11 in the first direction X is zero. The experimental data result for Comparative Example 1 is indicated by arrow F in FIG. 7.

As shown in FIG. 7, compared to Comparative Example 1, in Examples 1 to 4, the expansion force of the battery 11 decreases during the initial cycling phase due to contraction during the charge-discharge process, eventually falling below 3000 N. After approximately 400 cycles, as the battery expands, the expansion force begins to increase gradually and then continues to rise progressively.

Additionally, when the battery 11 is fully charged under a preload force in the range of 2800 N to 3200 N, the expansion force of the battery 11 exceeds the applied preload force.

In Examples 1 to 4, the capacity retention rate of the battery 11 after multiple charge-discharge cycles is higher than the capacity retention rate of the battery 11 in Comparative Example 1. Notably, when the spacing L2 between the clamping portion 71 and the battery 11 in the first direction X is 0.03L, the battery 11 achieves the highest capacity retention rate, thereby enhancing its cycle life.

The present application also provides a battery pack, including the battery module 100. The specific structure of the battery module 100 refers to the above embodiments. Since the battery pack adopts all the technical solutions of the above embodiments, it has all the advantageous effects brought by the technical solutions of the above embodiments, which will not be repeated here.

In the embodiments of this application, by providing a buffer member 2 between each adjacent pair of batteries 11 in the battery pack, a spacing is formed to accommodate expansion of the batteries 11 during cycling. Additionally, the buffer member 2 does not contact the non-overlapping region 4 of the positive electrode plates 110 and the negative electrode plates 111 in the first direction X, thereby preventing uneven distribution of expansion forces. This helps to slow capacity degradation of the batteries 11 and improves their cycle life.

Additionally, the present application also provides an electrical device including the above-described battery pack. The specific structure of the battery pack is as described in the foregoing embodiments. Since the electrical device incorporates all of the technical solutions described in the foregoing embodiments, it also benefits from all of the associated technical advantages, which will not be repeated here.

It should be understood that the electrical device includes, but is not limited to, electric toys, electric tools, electric vehicles, automobiles, ships, spacecraft, and the like. The electric toys may include fixed or mobile types, such as game consoles, electric car toys, electric ship toys, and electric airplane toys. The spacecraft may include aircraft, rockets, space shuttles, and spaceships. The automobiles may include fuel-powered vehicles, gas-powered vehicles, and new energy vehicles.

What is claimed is:

1. A battery module, comprising:
at least one battery group, comprising a plurality of batteries arranged along a first direction, each battery comprising a plurality of positive electrode plates and a plurality of negative electrode plates alternately stacked along the first direction, wherein the positive electrode plate and the negative electrode plate respectively comprise portions that overlap with each other in the first direction in an overlapping region, while a remaining portion of the negative electrode plate is in a non-overlapping region;
a plurality of buffer members, at least one of the buffer members being disposed between two adjacent ones of the batteries;
wherein an orthographic projection of the buffer member in the first direction is located within the overlapping region and outside the non-overlapping region.

2. The battery module according to claim 1, wherein, in a plane defined by a second direction and a third direction, a size of the negative electrode plate is larger than a size of the positive electrode plate;
wherein the first direction intersects the second direction, and the first direction and the second direction are perpendicular to the third direction.

3. The battery module according to claim 2, wherein an orthographic projection of the positive electrode plate in the first direction is entirely within the negative electrode plate to form the overlapping region;
wherein an orthographic projection of the buffer member in the first direction is entirely within the positive electrode plate.

4. The battery module according to claim 3, wherein, in the plane defined by the second direction and the third direction, a size of the buffer member is equal to the size of the positive electrode plate.

5. The battery module according to claim 1, wherein at least one of the negative electrode plate and the positive electrode plate includes a thinned portion, and a thickness of the thinned portion is less than a thickness of a remaining portion.

6. The battery module according to claim 1, wherein a size of the battery in the first direction is L, and a spacing between two adjacent batteries in the first direction is L1, wherein L and L1 satisfy: 0.02L≤L1≤0.05L.

7. The battery module according to claim 6, wherein L and L1 satisfy: L:L1=1:0.03.

8. The battery module according to claim 1, wherein the buffer member is elastic, having a compressed state and an uncompressed state;
wherein, in the first direction, a size of the buffer member in the compressed state is smaller than in the uncompressed state;
wherein the buffer member between two adjacent batteries is in the compressed state.

9. The battery module according to claim 8, wherein a dimension of the buffer member in the uncompressed state in the first direction is D1, and a dimension of the buffer member in the compressed state in the first direction is D2, wherein D1 and D2 satisfy: 0.41D1≤D2≤0.45D1.

10. The battery module according to claim 1, further comprising two end plates respectively disposed on opposite sides of the battery group in the first direction;
wherein one of the buffer members is disposed between each end plate and the adjacent battery.

11. A battery pack, comprising a battery module, wherein the battery module comprises:
at least one battery group, comprising a plurality of batteries arranged along a first direction, each battery comprising a plurality of positive electrode plates and a plurality of negative electrode plates alternately stacked along the first direction, wherein the positive electrode plate and the negative electrode plate respectively comprise portions that overlap with each other in the first direction in an overlapping region, while a remaining portion of the negative electrode plate is in a non-overlapping region;
a plurality of buffer members, at least one of the buffer members being disposed between two adjacent ones of the batteries;
wherein an orthographic projection of the buffer member in the first direction is located within the overlapping region and outside the non-overlapping region.

12. The battery pack according to claim 11, wherein, in a plane defined by a second direction and a third direction, a size of the negative electrode plate is larger than a size of the positive electrode plate;
wherein the first direction intersects the second direction, and the first direction and the second direction are perpendicular to the third direction.

13. The battery pack according to claim 12, wherein an orthographic projection of the positive electrode plate in the first direction is entirely within the negative electrode plate to form the overlapping region;
wherein an orthographic projection of the buffer member in the first direction is entirely within the positive electrode plate.

14. The battery pack according to claim 13, wherein, in the plane defined by the second direction and the third direction, a size of the buffer member is equal to the size of the positive electrode plate.

15. The battery pack according to claim 11, wherein at least one of the negative electrode plate and the positive electrode plate includes a thinned portion, and a thickness of the thinned portion is less than a thickness of a remaining portion.

16. The battery pack according to claim 11, wherein a size of the battery in the first direction is L, and a spacing between two adjacent batteries in the first direction is L1, wherein L and L1 satisfy: 0.02L≤L1≤0.05L.

17. The battery pack according to claim 11, wherein the buffer member is elastic, having a compressed state and an uncompressed state;
wherein, in the first direction, a size of the buffer member in the compressed state is smaller than in the uncompressed state;
wherein the buffer member between two adjacent batteries is in the compressed state.

18. The battery pack according to claim 17, wherein a dimension of the buffer member in the uncompressed state in the first direction is D1, and a dimension of the buffer member in the compressed state in the first direction is D2, wherein D1 and D2 satisfy: 0.41D1≤D2≤0.45D1.

19. The battery pack according to claim 11, further comprising two end plates respectively disposed on opposite sides of the battery group in the first direction;
wherein one of the buffer members is disposed between each end plate and the adjacent battery.

20. An electrical device, comprising a battery pack, wherein the battery pack comprises a battery module, the battery module comprising:
at least one battery group, comprising a plurality of batteries arranged along a first direction, each battery comprising a plurality of positive electrode plates and a plurality of negative electrode plates alternately stacked along the first direction, wherein the positive electrode plate and the negative electrode plate respectively comprise portions that overlap with each other in the first direction in an overlapping region, while a remaining portion of the negative electrode plate is in a non-overlapping region;
a plurality of buffer members, at least one of the buffer members being disposed between two adjacent ones of the batteries;
wherein an orthographic projection of the buffer member in the first direction is located within the overlapping region and outside the non-overlapping region.
